(19) United States
(12) Patent Application Publication
(10) Pub. No.: US 2020/0351890 A1
(43) Pub. Date: Nov. 5, 2020

(54) PHYSICAL DOWNLINK CONTROL CHANNEL MONITORING

(71) Applicant: MEDIATEK INC., Hsinchu (TW)

(72) Inventors: Cheng-Rung TSAI, Hsinchu (TW); Jiann-Ching GUEY, Hsinchu (TW)

(73) Assignee: MEDIATEK INC., Hsinchu (TW)

(21) Appl. No.: 16/863,430

(22) Filed: Apr. 30, 2020

Related U.S. Application Data
(60) Provisional application No. 62/842,682, filed on May 3, 2019.

(51) Int. Cl. H04W 72/04; H04W 24/08

(52) U.S. Cl. CPC H04W 72/0493; H04W 72/0446; H04W 72/042; H04W 24/08

(57) ABSTRACT

Aspects of the disclosure provide a method and an apparatus for monitoring physical downlink control channel (PDCCH). For example, the apparatus includes receiving circuitry and processing circuitry. The receiving circuitry can be configured to receive from a base station (BS) a search space set (SSS) and a start triggering signal. The SSS configures one or more PDCCH monitoring occasions. The processing circuitry can be configured to monitor PDCCH according to the SSS during a time window that extends from a start time that is a first time offset after the start triggering signal to an end time that is provided by the BS and/or determined based on a predefined rule.

### INCORPORATION BY REFERENCE

This present disclosure claims the benefit of U.S. Provisional Application No. 62/842,682, “PDCCH Monitoring for NR-U Operation” filed on May 3, 2019, which is incorporated herein by reference in its entirety.

### TECHNICAL FIELD

The present disclosure relates to wireless communications, and, more particularly, to a method and an apparatus for monitoring physical downlink control channel (PDCCH).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Typically, a wireless system includes multiple user equipment (UEs) and one or more base stations (BSs) communicatively coupled to the UEs. The BSs may be long term evolved (LTE) evolved NodeBs (eNBs) or new radio (NR) next generation NodeBs (gNBs) that can be communicatively coupled to the UEs by a Third-Generation Partnership Project (3GPP) network.

An NR network may configure certain resources for transmitting synchronization signals and/or reference signals to facilitate communications in the network. Accordingly, the UEs can monitor physical downlink control channel (PDCCH) to decode these signals.

### SUMMARY

Aspects of the disclosure provide a method for monitoring physical downlink control channel (PDCCH). The method can include receiving at a user equipment (UE) a search space set (SSS) from a base station (BS). For example, the SSS can configure one or more PDCCH monitoring occasions. The method can further include receiving from the BS a start triggering signal, and monitoring PDCCH according to the SSS during a time window. For example, the time window can extend from a start time that is a first time offset after the start triggering signal to an end time that is provided by the BS and/or determined based on a predefined rule.

According to some embodiments of the disclosure, the method can further include receiving from the BS an end triggering signal. For example, the end time can be a second time offset after the end triggering signal. The method can further include receiving from the BS a configuration of a timer. For example, the end time can be a third time offset after the timer expires.

Further, at least one of the first, second and third time offset can be provided by the BS or determined based on a predefined rule. The length of the time window can extend from and/or to a boundary of a slot. Additionally, the start triggering signal and the end triggering signal can be a downlink control information (DCI) or be indicated by a DCI.

According to some embodiments of the disclosure, the SSS is configured with a search space type, and monitoring PDCCH according to the SSS during the time window is performed based on the search space type.

Aspects of the disclosure further provide an apparatus, which can include receiving circuitry and processing circuitry. The receiving circuitry can be configured to receive from a BS an SSS, a start triggering signal, an end triggering signal, and a configuration of a timer. For example, the SSS can configure one or more PDCCH monitoring occasions. The processing circuitry can be configured to monitor PDCCH according to the SSS during a time window. The time window can extend from a start time that is a first time offset after the start triggering signal to an end time that is provided by the BS and/or determined based on a predefined rule. Further, the time window can extend to the end time that is a second time offset after the end triggering signal, or is a third offset after the timer expires.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a diagram showing an exemplary wireless communication system according to some embodiments of the disclosure;

FIG. 2 is a diagram showing some exemplary frame structures used in the wireless communication system corresponding to different subcarrier spacings according to some embodiments of the disclosure;

FIG. 3 is a diagram showing an exemplary communication frame configuration according to some embodiments of the disclosure.

FIG. 4 is a diagram showing some exemplary PDCCH monitoring occasions according to some embodiments of the disclosure;

FIG. 5 is a diagram showing a PDCCH monitoring mechanism employing a time window according to some embodiments of the disclosure;

FIG. 6 is a flow chart showing an exemplary method for monitoring PDCCH using the PDCCH monitoring mechanism of FIG. 5 according to some embodiments of the disclosure;

FIG. 7 is a flow chart showing another exemplary method for monitoring PDCCH using the PDCCH monitoring mechanism of FIG. 5 according to some embodiments of the disclosure;

FIG. 8 is a flow chart showing yet another exemplary method for monitoring PDCCH using the PDCCH monitoring mechanism of FIG. 5 according to some embodiments of the disclosure; and

FIG. 9 is a functional block diagram of an exemplary apparatus for monitoring PDCCH using the PDCCH monitoring mechanism of FIG. 5 according to some embodiments of the disclosure.

### DETAILED DESCRIPTION OF EMBODIMENTS

When a user equipment (UE) enters the coverage of a cell of a base station (BS), it can select and connect the cell, and exchange data with a base station (BS). For example, the BS can schedule downlink (DL) data to the UE, and the UE monitor physical downlink control channel (PDCCH) at PDCCH monitoring occasions configured by the BS for the DL data. However, it is not necessary for the BS to schedule the DL data at each PDCCH monitoring occasions. For example, the DL can be scheduled at PDCCH monitoring occasions within a time window dynamically. Accordingly, the UE can only monitor and decode the PDCCH at the PDCCH monitoring occasions with the time window, to reduce its power consumption.

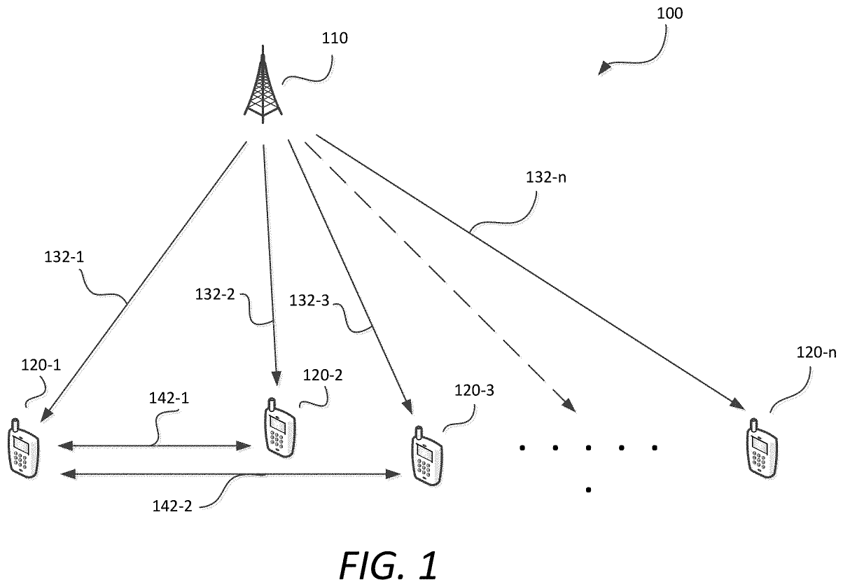

FIG. 1 is a diagram showing an exemplary wireless communication system 100 according to some embodiments of the disclosure. The wireless communication system 100 can include a base station (BS) 110, a first user equipment (UE) 120-1, a second UE 120-2, a third UE 120-3, . . . , and an nth UE 120-n. As shown, the BS 110 and the UEs 120 can wirelessly communicate with each other via radio interfaces (referred to as Uu interfaces, e.g., uplink radio interfaces) 132-1, 132-2, 132-3, . . . , 132-n, respectively, and the UEs 120 can also wirelessly communicate with each other via radio interfaces (referred to as PC5 interfaces, e.g., sidelink radio interfaces) 142-1 and 142-2.

The BS 110 can be any device that wirelessly communicates with the UEs 120 via uplink radio interfaces 132. For example, the BS 110 can be an implementation of a gNB specified in the 3GPP New Radio (NR) standard. Alternatively, the BS 110 can be an implementation of an eNB specified in 3GPP Long Term Evolution (LTE) standard. Accordingly, the BS 110 can communicate with the UEs 120 via the uplink radio interfaces 132 according to respective wireless communication protocols. In yet other embodiments, the BS 110 can implement other types of standardized or non-standardized radio access technologies, and communicate with the UEs 120 according to the respective radio access technologies. The BS 110 can provide communication coverage for a particular geographic area.

The UEs 120 can be any device that is capable of wirelessly communicating with the BS 110 via the uplink radio interfaces 132, as well as communicating with the UEs 120 via the sidelink radio interfaces 142. For example, the UEs 120 can be a vehicle, a computer, a mobile phone, and the like. The sidelink radio interfaces 142 can be a direct radio link established between the UEs 120. In V2X, the sidelink communication includes vehicle to vehicle (V2V) communication, mobile phone to mobile phone communication, device to device (D2D) communication, and the like. For example, as shown in FIG. 1, the first UE 120-1 can communicate with the second UE 120-2 and the third UE 120-3 via the first sidelink radio interface 142-1 and the second sidelink radio interface 142-2, respectively.

The BS 110 can transmit cell specific reference signals (CRSs) and channel state information-reference signals (CSI-RS) to enable the UEs 120 to estimate a downlink (DL) channel. The UEs 120 can transmit sounding reference signals (SRSs) to enable the BS 110 to estimate an uplink (UL) channel.

The BS 110 can also transmit synchronization signals (SSs) (e.g., including a primary synchronization signal (PSS) and a secondary synchronization signal (SSS)) to enable the UEs 120 to facilitate synchronization with the BS 110. The BS 110 can broadcast system information (e.g., including a master information block (MIB) and remaining minimum system information (RMSI)) to enable the UEs 120 to facilitate initial network access. For example, the BS 110 can broadcast the PSS, the SSS, the MIB and the RMSI in the form of a synchronization signal block (SSB).

The UEs 120 can perform an initial cell search by detecting the PSS from the BS 110. The PSS can enable synchronization of period timing and indicate a physical layer identity value. The UEs 120 can then receive the SSS, which can enable radio frame synchronization and provide a cell identity value. After receiving the PSS and the SSS, the UEs 120 can receive the MIB, which is transmitted in a physical broadcast channel (PBCH) and includes system information for initial network access. After obtaining the MIB, the UEs 120 can perform a random access procedure to establish a connection with the BS 110.

After the connection with the BS 110 is established, the UEs 120 can exchange operational data with the BS 110. For example, the BS 110 can transmit a UL grant and/or a DL grant for the UE 120 in a DL control region of a transmission slot, and the UE 120 can then communicate with the BS 110 in a data region of a subsequent transmission slot based on the UL grant and/or the DL grant.

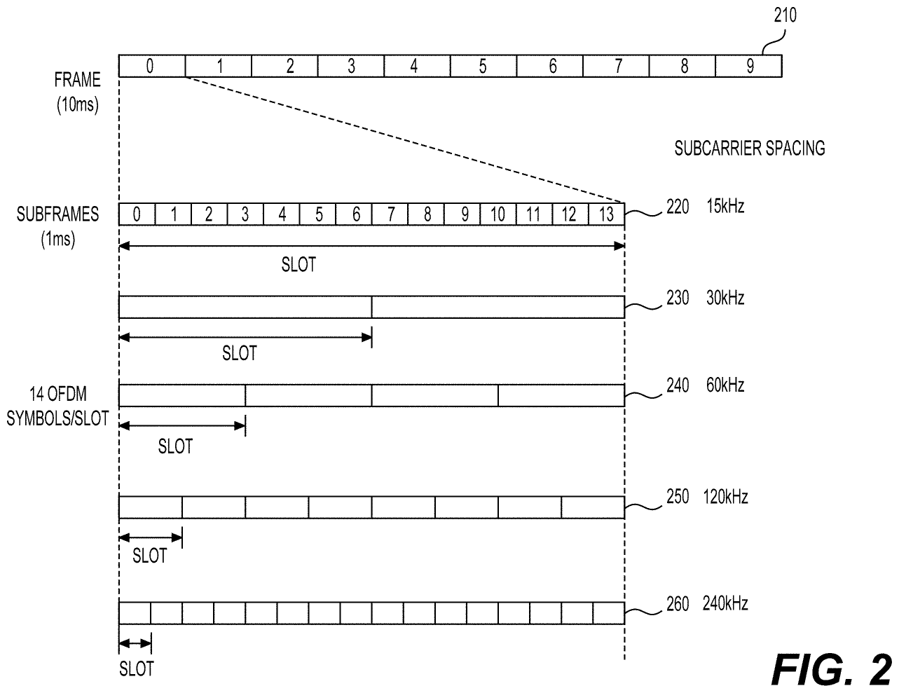

FIG. 2 shows exemplary frame structures used in the wireless communication system 100 corresponding to different subcarrier spacings according to some embodiments of the disclosure. The BS 110 and the UEs 120 can communicate with each other using the frame structures. A radio frame 210 can last for 10 ms and include 10 subframes that each last for 1 ms. Corresponding to different numerologies and respective subcarrier spacings, a subframe may include different number of slots. For example, for a subcarrier spacing of 15 kHz, 30 kHz, 60 kHz, 120 kHz, or 240 kHz, a respective subframe 220-260 can include 1, 2, 4, 8, or 16 slots, respectively. Each slot may include 14 OFDM symbols in one example. In alternative examples, different frame structures may be employed. For example, a slot may include 7 or 28 OFDM symbols.

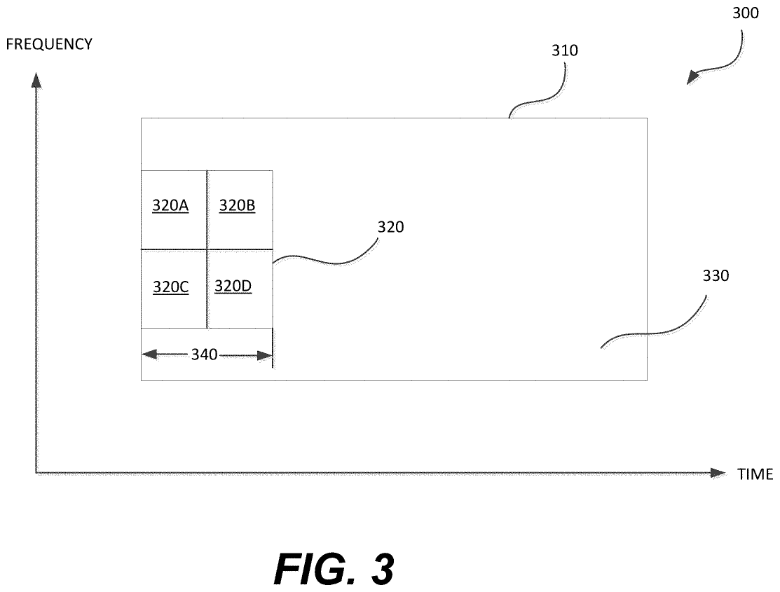

FIG. 3 shows an exemplary communication frame configuration 300 according to some embodiments of the disclosure. The BS 110 and the UEs 120 can employ the communication frame configuration 300 to communicate with each other. The communication frame configuration 300 can include a transmission slot 310 that includes any number of OFDM symbols. The transmission slot 310 can include a DL control region 340. The DL control region 340 can include a set of resources 320 spanning in time and frequency designated for DCI transmission. The DL control region 340 can be located at the beginning of the transmission slot 310 and include a duration of two to three symbols. DCI can include UL scheduling grants and/or DL scheduling grants. The remaining time-resources 330 of the communication frame configuration 300 can be allocated for physical downlink shared channel (PDSCH) transmission or physical uplink shared channel (PUSCH) transmission.

The set of resources 320 can be referred to as a control resource set (CORESET). A CORESET can include a plurality of resource blocks (RBs) in the frequency domain and a plurality of symbols in the time domain. A plurality of DL control channel search spaces 320A-320D can be mapped to the CORESET 320, and each carry a physical downlink control channel (PDCCH) candidate (e.g., DCI or a DL control message). In an embodiment, the search spaces 320A-320D can be periodic. For example, the search space 320A can be configured for a particular slot 310, and repeated at every L number of slots 310, where L may be any suitable integer. In other words, the search space 320A can correspond to time instances of the CORESET 320 where PDCCH monitoring can be performed by the UEs 120. Accordingly, a set of PDCCH candidates for the UEs 120 to monitor is defined in terms of PDCCH search space sets (SSSs). The UEs 120 can monitor PDCCH for each search space set (e.g., the search spaces 320A-320D) in the CORESET 320.

In operation, the BS 110 can transmit configurations for a CORESET (e.g., the CORESET 320), PDCCH candidate search spaces (e.g., the search spaces 320A-320D), and preconfigured resources, schedule and transmit DCI based in the search spaces. In some embodiments of the disclosure, each PDCCH candidate search space may be referred to as a PDCCH candidate, and the set of PDCCH candidates within an instance of a CORESET may be referred to as a search space set or a search space. Accordingly, the UEs 120 can receive search space configurations from the BS 110, obtain the CORESET 320, the PDCCH candidate search spaces 320A-320D and the preconfigured resources from the search space configurations, monitor for PDCCH candidates, and process received PDCCH signals based on the obtained CORESET 320, the search spaces 320A-320D, and the preconfigured resources.

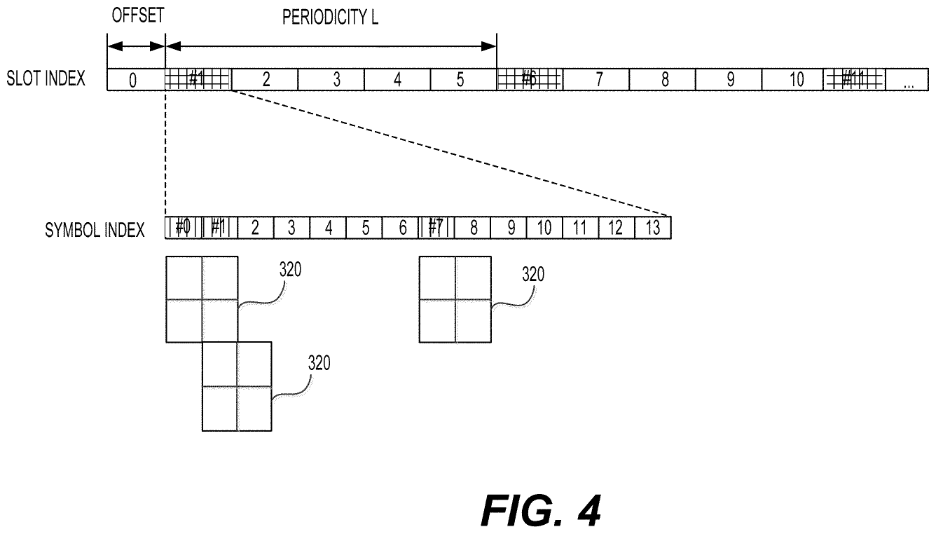

FIG. 4 shows exemplary PDCCH monitoring occasions according to some embodiments of the disclosure. The BS 110 can allocate one or more search space sets (SSSs) to the UE 120. The SSS can configure one or more PDCCH monitoring occasions. In a configuration for SSS, the following parameters are provided: search space ID, an identity of a CORESET (e.g., the CORESET 320) that the SSS is associated with, information of search space type (e.g., common search space type 0), and information of PDCCH monitoring occasions. On each PDCCH monitoring occasion, the UE 120 can attempt to detect PDCCH transmitted by the BS 110 according to the associated CORESET configuration and the information of search space type. As shown, the information of the PDCCH monitoring occasions includes the following parameters: the offset of the PDCCH monitoring slot that is one slot, the periodicity L of PDCCH monitoring slots that is five slots, and the starting symbol(s) for PDCCH monitoring within one of the periodic PDCCH monitoring slots #1, #6 and #11 that is a bitmap [1, 1, 0, 0, 0, 0, 0, 1, 0, 0, 0, 0, 0, 0]. Accordingly, the UE 120 can attempt to monitor PDCCH at symbols #0, #1 and #7 of the PDCCH monitoring slots #1, #6 and #11.

The UE 120 can detect PDCCH for DCI at PDCCH monitoring occasions. However, the BS 110 can schedule DL data by transmitting PDCCH in some of the PDCCH monitoring occasions. Accordingly, the UE 120 does not need to detect PDCCH on every PDCCH monitoring occasion. A time window is employed according to the disclosure, in order to save the power consumption of the UE 120. For example, the UE 120 can attempt to decode the PDCCH at the PDCCH monitoring occasions only within the time window.

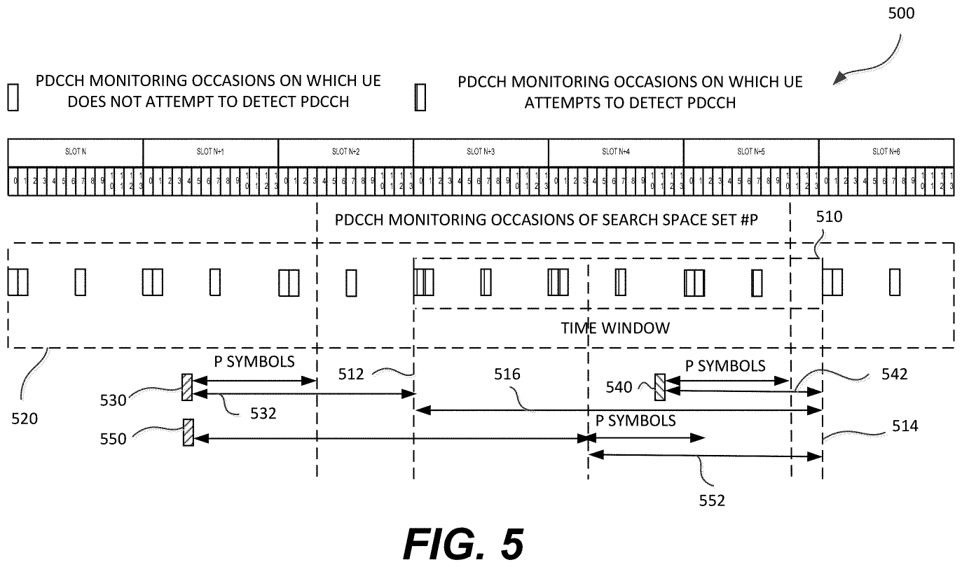

FIG. 5 is a diagram showing a PDCCH monitoring mechanism 500 employing a time window 510 according to some embodiments of the disclosure. According to a specific SSS # P, the UE 120 is supposed to decode PDCCH at all PDCCH monitoring occasions (e.g., including the PDCCH monitoring occasions on which the UE 120 attempts and does not attempt to detect PDCCH, which are all within a dashed rectangle 520). However, the BS 110 may schedule DL data by transmitting PDCCH in certain PDCCH monitoring occasions only, for example, the PDCCH monitoring occasions within the time window 510. Accordingly, the UE 120 only needs to detect and decode the PDCCH at the PDCCH monitoring occasions within the time window 510.

For example, the time window 510 can extend from a start time 512 to an end time 514. In an embodiment, the length 516 of the time window 510 extends from a boundary of a slot to another boundary of another slot, which is beneficial for both the UE 120 implementation and the BS 110 scheduling. For example, the length 516 can extend from the first symbol of a slot SLOT N+3 to the last symbol of a slot SLOT N+5. As shown, the start time 512 can be a first time offset 532 after a start triggering signal 530, and the end time 514 can be a second time offset 542 after an end triggering signal 540.

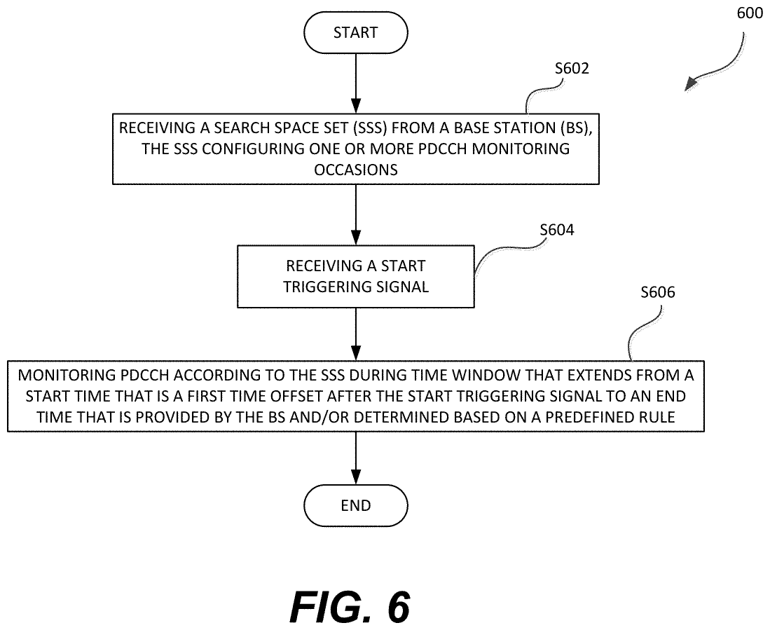

FIG. 6 is a flow chart of an exemplary method 600 for monitoring PDCCH by using the PDCCH monitoring mechanism 500 according to some embodiments of the disclosure. According to the method 600, only the PDCCH at PDCCH monitoring occasions within the time window 510 will be monitored.

At step S602, a search space set (SSS) can be received at the UE 120 from the BS 110. According to some embodiments, the SSS can configure one or more PDCCH monitoring occasions. For example, the SSS can configure the periodicity L of the PDCCH monitoring slot to be one slot, and configure PDCCH monitoring occasions to be at the first, second and eighth symbols of a slot SLOT N to a slot SLOT N+6 within the dashed rectangle 520 (as shown in FIG. 5).

At step S604, the UE 120 can receive the start triggering signal 530 transmitted by the BS 110. According to some embodiments, the start triggering signal 530 can be a DL signal from the BS 110. Accordingly, the UE 120 can attempt to detect PDCCH at the PDCCH monitoring occasions within the time window 510 after detecting the DL signal. In an embodiment, the DL signal can be a DCI from the BS 110. In another embodiment, the start triggering signal 530 can be indicated by a DCI from the BS 110. For example, the start triggering signal 530 is a DCI that has a flag/field configured to a certain value (for example, “1”). For another example, the BS 110 can transmit to the UE 120 a DCI indicating a duration, the last symbol or slot of which can configure the start triggering signal 530.

At step S606, the UE 120 can attempt to monitor and decode PDCCH at the PDCCH monitoring occasions according to the SSS only within the time window 510, which can extend from the start time 512 to the end time 514. In an embodiment, the start time 512 is the first time offset 532 after the start triggering signal 530. For example, according to a predefined rule the first time offset 532 can begin at a next applicable slot, which is the first slot that is at least N symbols (as shown in FIG. 5) after the start triggering signal 530, e.g., after the last symbol of the duration that is indicated by the DCI or after the last symbol of the PDCCH with the DCI that has the flag/field carrying the certain value. In some embodiments, N can be a predefined value or be configured by the BS 110.

In an embodiment, the end time 514 can be provided by the BS 110 or determined based on a predefined rule, and can be the second time offset 542 after the end triggering signal 540. In an embodiment, the end triggering signal 540 can be a DCI from the BS 110. In another embodiment, the end triggering signal 540 can be indicated by a DCI from the BS 110. For example, the end triggering signal 540 is a DCI that has a flag/field configured to another certain value (for example, “0”). For another example, the BS 110 can transmit to the UE 120 a DCI indicating a duration, the last symbol or slot of which can configure the end triggering signal 540. In some other embodiments, according to a predefined rule the second time offset 542 can begin at a next applicable slot, which is the first slot that is at least N symbols (as shown in FIG. 5) after the end triggering signal 540, e.g., after the last symbol of the duration that is indicated by the DCI or after the last symbol of the PDCCH with the DCI that has the flag/field carrying the another certain value. In some embodiments, N can be a predefined value or be configured by the BS 110.

According to some embodiments of the disclosure, the SSS can be configured with a search space type, and the UE 120 can monitor the PDCCH according to the SSS during the time window 510 based on the search space type. For example, the search space type can indicate an SSS with a group index 0 that configures one or more denser PDCCH monitoring occasions, or indicate another SSS with a group index 1 that configures one or more sparser PDCCH monitoring occasions, and the UE 120 can detect the PDCCH at the PDCCH monitoring occasions according to the SSS within the time window 510 only when the search space type indicates the SSS with the group index 1.

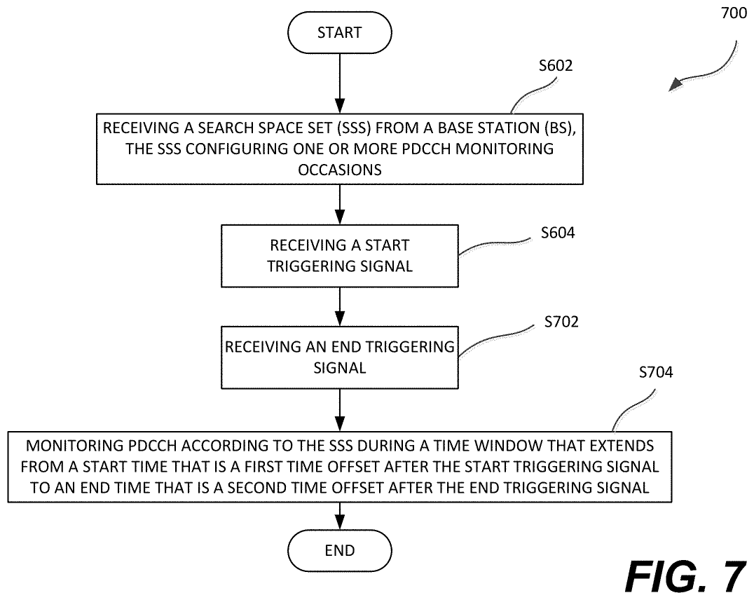

FIG. 7 is a flow chart of another exemplary method 700 for monitoring PDCCH by using the PDCCH monitoring mechanism 500 according to some embodiments of the disclosure. According to the method 700, only the PDCCH at PDCCH monitoring occasions within the time window 510 will be monitored. The method 700 can include steps S602, S604, S702 and S704.

After receiving the SSS and the start triggering signal 530 at steps S602 and S604, respectively, the UE 120 can further receive the end triggering signal 540, at step S702. At step S704, the UE 120 can attempt to decode PDCCH at the PDCCH monitoring occasions only within the time window 510, which can extend from the start time 512 to the end time 514. In an embodiment, the start time 512 is the first time offset 532 after the start triggering signal 530. In another embodiment, the end time 514 is the second time offset 542 after the end triggering signal 540. In yet another embodiment, the second time offset 542 is provided by the BS 110 and/or determined based on a predefined rule. For example, according to the predefined rule the second time offset 542 can begin at a next applicable slot, which is the first slot that is at least N symbols (as shown in FIG. 5) after the end triggering signal 540. In some embodiments, the value of N can be configured by the BS 110 via a higher layer signaling.

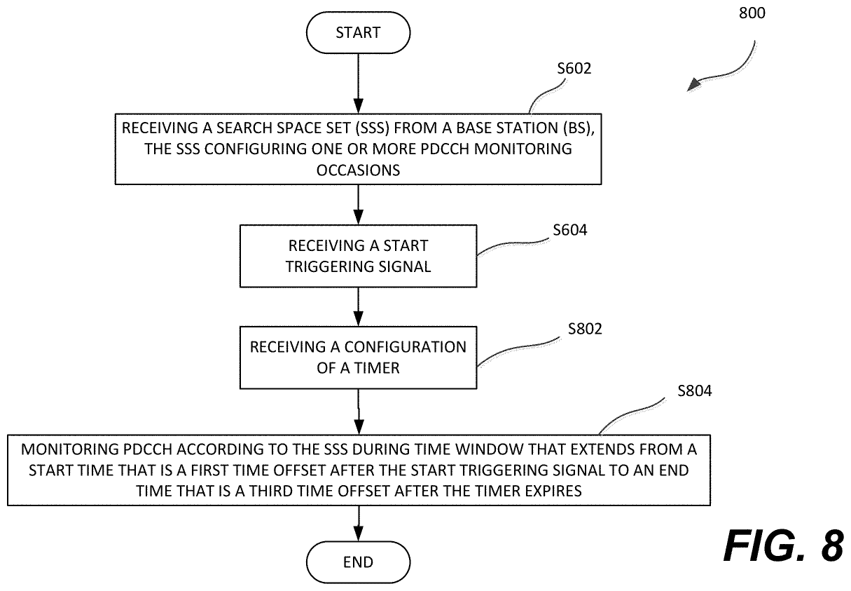

FIG. 8 is a flow chart of yet another exemplary method 800 for monitoring PDCCH by using the PDCCH monitoring mechanism 500 according to some embodiments of the disclosure. According to the method 800, only the PDCCH at PDCCH monitoring occasions within the time window 510 will be monitored. The method 800 can include steps S602, S604, S802 and S804.

After receiving the SSS and the start triggering signal 530 at steps S602 and S604, respectively, the UE 120 can further receive a configuration 550 of a timer from the BS 110, at step S802. For example, the configuration 550 of the timer is 3 slots, as shown in FIG. 5. At step S804, the UE 120 can attempt to decode PDCCH at the PDCCH monitoring occasions only within the time window 510, which can also extend from the start time 512 to the end time 514. In an embodiment, the end time 514 is a third time offset 552 after the timer expires. Similarly, the third time offset 552 can also be provided by the BS 110 and/or determined based on a predefined rule. For example, according to the predefined rule the third time offset 552 can begin at a next applicable slot, which is the first slot that is at least N symbols (as shown in FIG. 5) after the timer expires. In some embodiments, the value of N can be configured by the BS 110 via a higher layer signaling.

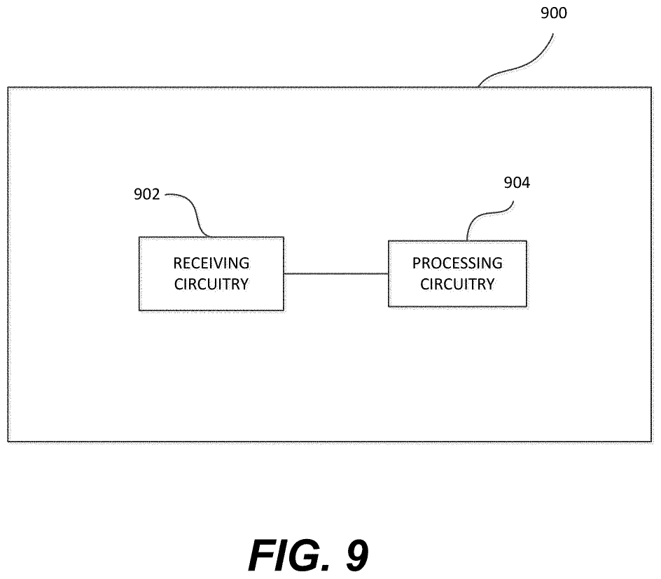

FIG. 9 shows an exemplary apparatus 900 according to some embodiments of the disclosure. The apparatus 900 can be configured to perform various functions in accordance with one or more embodiments or examples described herein. Thus, the apparatus 900 can provide means for implementation of techniques, processes, functions, components, systems described herein. For example, the apparatus 900 can be used to implement functions of the UE 120 in various embodiments and examples described herein. The apparatus 900 can be a general purpose computer in some embodiments, and can be a device including specially designed circuits to implement various functions, components, or processes described herein in other embodiments. The apparatus 900 can include receiving circuitry 902 and processing circuitry 904.

In an embodiment, the receiving circuitry 902 can be configured to receive from the BS 110 the SSS, the start triggering signal 530, the end triggering signal 540, and the configuration 550 of the timer. For example, the SSS can configure one or more PDCCH monitoring occasions. In another embodiment, the processing circuitry 904 can be configured to monitor PDCCH according to the SSS during the time window 510, which can extend from the start time 512 to the end time 514. For example, the start time 512 can be the first time offset 532 after the start triggering signal 530. For another example, the end time 514 can be the second time offset 542 after the end triggering signal 540. For yet another example, the end time 514 can be the third time offset 552 after the timer expires. In an embodiment, at least one of the start triggering signal 530 and the end triggering signal is a DCI, or is indicated by a DCI. In another embodiment, the end time 514 can be provided by the BS or determined based on a predefined rule. In yet another embodiment, at least one of the first time offset 532, the second time offset 542 and the third time offset 552 can be provided by the BS or determined based on a predefined rule.

In some embodiments according to the disclosure, the receiving circuitry 902 and the processing circuitry 904 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other embodiments according to the disclosure, the processing circuitry 904 can be a central processing unit (CPU) configured to execute program instructions to perform various functions and processes described herein.

The apparatus 900 can optionally include other components, such as input and output devices, additional or signal processing circuitry, and the like. Accordingly, the apparatus 900 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

In some embodiments, the phrase “A and/or B” can mean “A alone,” “B alone,” or “A and B together.”

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for monitoring physical downlink control channel (PDCCH), comprising:
receiving at a user equipment (UE) a search space set (SSS) from a base station (BS), wherein the SSS configures one or more PDCCH monitoring occasions;
receiving from the BS a start triggering signal;
monitoring PDCCH according to the SSS during a time window that extends from a start time that is a first time offset after the start triggering signal to an end time that is provided by the BS and/or determined based on a predefined rule.

2. The method of claim 1, wherein the first time offset is provided by the BS or determined based on a predefined rule.

3. The method of claim 1, wherein the length of the time window extends from a boundary of a slot.

4. The method of claim 1, wherein the start triggering signal is a downlink control information (DCI).

5. The method of claim 1, wherein the start triggering signal is indicated by a DCI.

6. The method of claim 1, wherein the SSS is configured with a search space type, and monitoring PDCCH according to the SSS during the time window is performed based on the search space type.

7. The method of claim 1, further comprising:
receiving from the BS an end triggering signal, wherein the end time is a second time offset after the end triggering signal.

8. The method of claim 7, wherein the second time offset is provided by the BS or determined based on the predefined rule.

9. The method of claim 7, wherein the end triggering signal is a DCI.

10. The method of claim 7, wherein the end triggering signal is indicated by a DCI.

11. The method of claim 1, further comprising:
receiving from the BS a configuration of a timer, wherein the end time is a third time offset after the timer expires.

12. The method of claim 11, wherein the third time offset is provided by the BS or determined based on the predefined rule.

13. The method of claim 1, wherein the length of the time window extends to a boundary of a slot.

14. An apparatus, comprising:
receiving circuitry configured to receive from a BS an SSS and a start triggering signal, wherein the SSS configures one or more PDCCH monitoring occasions; and
processing circuitry configured to monitor PDCCH according to the SSS during a time window that extends from a start time that is a first time offset after the start triggering signal to an end time that is provided by the BS and/or determined based on a predefined rule.

15. The apparatus of claim 14, wherein the first time offset is provided by the BS or determined based on a predefined rule.

16. The apparatus of claim 14, wherein the start triggering signal is a DCI.

17. The apparatus of claim 14, wherein the start triggering signal is indicated by a DCI.

18. The apparatus of claim 14, wherein the SSS is configured with a search space type, and the processing circuitry is configured to monitor PDCCH according to the SSS during the time window based on the search space type.

19. The apparatus of claim 14, wherein the receiving circuitry is further configured to receive from the B S an end triggering signal, and the end time is a second time offset after the end triggering signal.

20. The apparatus of claim 19, wherein the second time offset is provided by the B S or determined based on the predefined rule.

21. The apparatus of claim 19, wherein the end triggering signal is a DCI.

22. The apparatus of claim 19, wherein the end triggering signal is indicated by a DCI.

23. The apparatus of claim 14, wherein the receiving circuitry is further configured to receive from the BS a configuration of a timer, and the end time is a third time offset after the timer expires.

24. The apparatus of claim 14, wherein the third time offset is provided by the BS or determined based on the predefined.

25. The apparatus of claim 14, wherein the length of the time window extends from a boundary of a slot.

26. The apparatus of claim 14, wherein the length of the time window extends to a boundary of a slot.
